(19) United States
(12) Patent Application Publication
(10) Pub. No.: US 2007/0066397 A1
(43) Pub. Date: Mar. 22, 2007

(54) System and method for event invitation

(76) Inventors: Krishnakant Nammi, Seattle, WA (US); Peter K. Schneeberger, Columbia, MO (US)

Correspondence Address: JABLONSKI AND REID, PLLC, 218 MAIN STREET, #140, KIRKLAND, WA, 98033, US

(21) Appl. No.: 11/231,492

(22) Filed: Sep. 20, 2005

(51) Int. Cl. A63F 9/24

(52) U.S. Cl. 463/42

(57) ABSTRACT

A computer-related system and computer-implemented method for coordinating attendance of an event. The method may begin at a host computer associated with a host by selecting an event from a plurality of events. The event associated with a special arrangement, such as a ticket or fee, for a attendance to the event. The, the host may send a notification to at least one computer associated with an invited guest about the reservation, the notification including an invitation to the event. The invited guest may then respond and in response to the invited guest accepting the invitation, a transaction for completing the special arrangement is invoked. For example, the ticket(s) to the event may be purchased.

### BACKGROUND OF THE INVENTION

Computer technology has enabled computer systems in conjunction with various communication mediums to develop models for organizing, coordinating, and generally dealing with ticketed events such as a professional baseball games, rock concerts, etc. Dial-up telephone centers, internet websites, and the like are available to provide centralized systems for offering, selling, and distributing tickets to various events. For example, an individual may visit a website and peruse through a list of events that may be upcoming in a particular area. As such, the individual may then request one or more tickets to a chosen event, arrange for payment of the ticket(s), and then arrange for delivery or pickup of the ticket(s).

Often times, people prefer attending these events in groups of two or more due to the social nature of many ticketed events. As such, it is also preferable to sit together in a group of seats which typically requires purchasing the tickets for these preferred seating arrangements at the same time. That is, to ensure that two people (or more) get to sit together at the event, it is often far easier to purchase the tickets at the same time as opposed to each individual having to arrange for a specific ticket next to their friend or friends. Therefore, it is typically incumbent upon one individual to purchase all the tickets to an event and then make arrangements for all others in the group to pay the individual back.

Several potential issues may arise when people make these kinds of social arrangements. For one, despite the best planning, sometimes when an individual purchases a ticket for each person in a group, miscommunication occurs such that an extra ticket is purchased, but no person is available to use the ticket. Thus, the extra ticket may go unused or the buyer is forced to trade for below face value. Another related problem that may arise is not purchasing enough tickets for the group. Furthermore, the group may be so large that one individual is not willing to take on the financial risk of not getting paid back by everybody in the group.

In addition to problems regarding purchasing the right amount of tickets, it is often the case that “hot ticket” events may sell out quickly, thus forcing individuals and groups to make decisions under the pressure of time. By the time each person in a group commits to going to an event, the event may be sold out or a large grouping of tickets may not be available any longer to accommodate the group sitting together.

Similarly, an individual may wish to invite one other person to go to an event, but does not want to purchase the ticket until the other person is able to commit to attending the event. Thus, the initiator must either take a chance on buying the ticket and then inquiring about the other person's availability or wait until verifying the other person can go at the risk of not getting a ticket to a hot-ticket event. Furthermore, there may individuals who would like to attend an event but only if they are able to go with another person, thus, take a risk in purchasing a ticket but not attending because they could not find another person with whom they may purchase tickets and/or attend.

It would beneficial to have a more predictable and less-risky manner for organizing, coordinating, and purchasing tickets for events when individuals or groups are wishing to attend such events.

### SUMMARY OF THE INVENTION

Embodiments of the invention are directed to a computer-implemented system and method for coordinating the attendance of two or more individuals to an event. As such, an individual or company who may be the “host” of an event may coordinate the invitation of one or more guests to the event, make arrangements for ticket or attendance fee purchase, and arrange for specific circumstances in which the invited guests may accept the invitation.

In one embodiment, the host may select an event, such as a baseball game or musical concert, that is typically associated with a attendance arrangement, i.e., a ticket or entrance fee, for attendance to the event. Then, the host may send a notification to at least one computer associated with an invited guest about the reservation, the notification including an invitation to the event. The invited guest may then respond to the invitation and, in response to accepting the invitation, the tickets to the event may be purchased according to pre-arranged instructions (i.e., which person pays, how to pay, etc.).

The event may be any possible event that typically requires special arrangements for admission. Typically, the special arrangement may be a purchased ticket and some examples of such ticketed events may include, but are not limited to, sporting events, concerts, trade shows, festivals, club meetings, movies, theatre shows, etc. In other embodiments, the event may be of a more commercial nature such as hotel packages, vacation packages, travel, car rentals, marketing events, rewards programs, redeemable vouchers, job interviews, and the like. Thus, the special arrangements for attendance may other kinds of transactions, such as redemption of reward points, a binding to accept a offer (a credit card offer, for example), or just about any other arrangement in which the guest(s) accepting the invitation is subject to an agreement upon accepting the invitation. Generally speaking, a host may invite guests to an event whereby the acceptance of the invitation invokes acquiring the means for attending the event via some transaction.

The methods and systems of the invention may be applicable to a number of hosting situations. In an obvious example, a host may easily coordinate purchasing tickets and attending an event, such as a football game, involving a group of friends. In a different manner a host may wish to offer to take a user/guest on a date by extending an invitation that includes purchasing tickets to a concert. In a more commercial setting, a host may be a company that uses a commercial rewards system to promote customer loyalty. Still further yet, a host company may implement a marketing system within the context of the invention.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a computing environment suitable for practicing various embodiments of the invention;

FIG. 2 is a flow chart of a method for an individual host to invite one or more guests by purchasing tickets and then verifying attendance according to an embodiment of the invention;

FIG. 3 is a flow chart of a method for an individual host to invite one or more guests by reserving one or more tickets and then purchasing after verifying attendance according to an embodiment of the invention;

FIG. 4 is a flow chart of a method for an individual host to invite a plurality of guests by reserving tickets and then enabling each invited guest to purchase a ticket upon verification of attendance according to an embodiment of the invention;

FIG. 5 is a flow chart of a method for an individual host to invite one or more guests by purchasing tickets and then verifying an attendance threshold upon which the event's occurrence is based, according to an embodiment of the invention;

FIG. 6 is a flow chart of a method for an individual host to invite one or more guests by reserving one or more tickets and then purchasing after verifying a threshold attendance according to an embodiment of the invention;

FIG. 7 is a flow chart of a method for an individual host to invite one or more hidden guests through matching profiles of potential invited guests by purchasing tickets and then verifying attendance according to an embodiment of the invention;

FIG. 8 is a flow chart of a method for an individual host to invite one or more hidden guests through matching profiles of potential invited guests by reserving one or more tickets and then arranging for their purchase by the host or guest after verifying attendance according to an embodiment of the invention;

FIG. 9 is a flow chart of a method for an individual host to invite one or more guests through matching profiles of potential invited guests by selecting among the potential guests, by purchasing tickets and then verifying attendance according to an embodiment of the invention;

FIG. 10 is a flow chart of a method for an individual host to invite one or more guests by matching profiles of potential invited guests by selecting among the invited guests, by reserving one or more tickets and then purchasing or suggest purchasing after verifying attendance according to an embodiment of the invention;

FIG. 11 is a flow chart of a method for an individual host to invite one or more guests through matching profiles of potential guests by purchasing tickets and then by verifying attendance of the invited guest that is a first responder, according to an embodiment of the invention;

FIG. 12 is a flow chart of a method for an individual host to invite one or more guests through matching profiles of potential invited guests by reserving one or more tickets and then by purchasing after verifying attendance of the invited guest that is a first responder according to an embodiment of the invention;

FIG. 13 is a flowchart of a method for enabling users of a matching profile system to request a match and then arrange for the purchase of tickets based on profile criteria selected by each user and a verification of attendance to an event;

FIG. 14 is a flow chart of a method for a committed guest be chosen for an invitation from a host who requests a profile match of potential guests, wherein the host purchases the tickets prior to initiating the invitation;

FIG. 15 is a flow chart of a method for a committed guest to accept an invitation from a host who requests a profile match of potential guests, wherein the host purchases the tickets when initiating the invitation;

FIG. 16 is a flow chart of a method for a committed guest to accept an invitation from a host who requests a profile match of potential guests, wherein the host requests the committed guest to purchase the ticket or tickets when initiating the invitation;

FIG. 17 is a flow chart of a method for a committed guest to accept an invitation from a host who requests a profile match of multiple potential guests wherein the host selects one potential guest as the invited guest and then purchases the tickets when initiating the invitation; and

FIG. 18 is a flow chart of a method for a committed guest to accept an invitation from a host who requests a profile match of potential guests wherein the host selects one potential guest as the invited guest and requests the committed guest to purchase the ticket or tickets when initiating the invitation.

### DETAILED DESCRIPTION

The following discussion is presented to enable a person skilled in the art to make and use the invention. The general principles described herein may be applied to embodiments and applications other than those detailed above without departing from the spirit and scope of the present invention. The present invention is not intended to be limited to the embodiments shown, but is to be accorded the widest scope consistent with the principles and features disclosed or suggested herein.

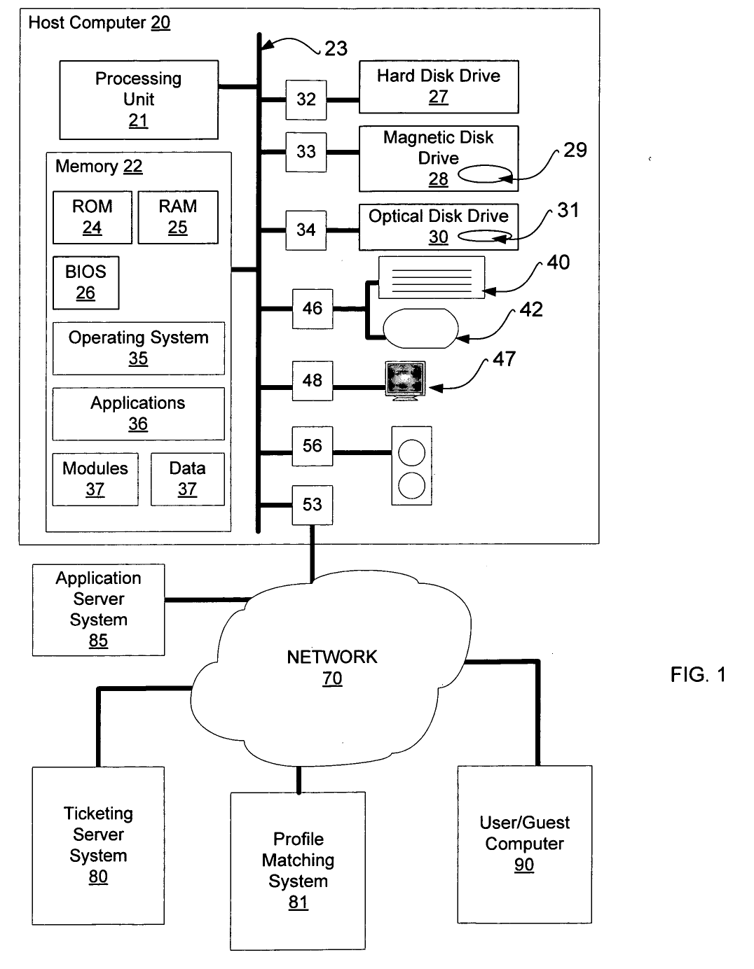

FIG. 1 and the following discussion are intended to provide a brief, general description of a suitable computing environment in which the invention may be implemented. The computing environment is only one example of a suitable environment and is not intended to suggest any limitation as to the scope of use or functionality of the invention. Neither should the computing system environment be interpreted as having any dependency or requirement relating to any one or combination of components illustrated in the exemplary operating environment.

The invention is operational with numerous general purpose or special purpose computing systems or configurations. Examples of well known computing systems, environments, and/or configurations that may be suitable for use with the invention include, but are not limited to: personal computers, server computers, hand-held or laptop devices, tablet devices, headless servers, multiprocessor systems, microprocessor-based systems, set top boxes, programmable consumer electronics, network PCs, minicomputers, mobile or cell phones, personal data assistants, mainframe computers, distributed computing environments that include any of the above systems or devices or any combinations of the afore mentioned, and the like.

Although not required, the invention will be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote memory storage devices.

With reference to FIG. 1, an exemplary system for implementing the invention includes a general purpose computing device in the form of a conventional host computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory 22 includes read only memory (ROM) 24 and random access memory (RAM) 25. A basic input/output system (BIOS) 26, containing the basic routines that help to transfer information between elements within the personal computer 20, such as during start-up, is stored in ROM 24.

The personal computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide nonvolatile storage of computer readable instructions, data structures, program modules and other data for the personal computer 20.

Although the exemplary environment described herein employs a hard disk, a removable magnetic disk 29 and a removable optical disk 31, it should be appreciated by those skilled in the art that other types of computer-readable media which can store data that is accessible by a computer, such as magnetic cassettes, flash memory cards, digital versatile disks, Bernoulli cartridges, random access memories (RAMs), read only memories (ROM), and the like, may also be used in the exemplary operating environment.

A number of program modules may be stored on the hard disk, magnetic disk 29, optical disk 31, ROM 24 or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB). A monitor 47 or other type of display device is also connected to the system bus 23 via an interface, such as a video adapter 48. One or more speakers 57 are also connected to the system bus 23 via an interface, such as an audio adapter 56. In addition to the monitor and speakers, personal computers typically include other peripheral output devices (not shown), such as printers.

The host computer 20 typically operates in a networked environment using logical connections to one or more remote computers, such as user/guest computer 90. Each remote computer may be another personal computer, a server, a router, a network PC, a peer device, a mobile phone, a personal data assistant, or other common network node, and typically includes many or all of the elements described above relative to the host computer 20,. The logical connections typically route through a network 70 that may be local area network (LAN), a wide area network (WAN), and/or the Internet. As depicted in FIG. 1, the host computer 20 communicates with the network 70, and subsequently other computers, via a network interface card 53

The distributed network of FIG. 1 includes the host computer 20, a user/guest computer 90, a ticketing server computer system 80, an application server system 85, and a profile matching computer system 81. As discussed above, these computing systems need not necessarily be limited to the embodiment shown in FIG. 1 as any of these systems may be accomplished within one computing environment or any combination of environments linked through the network 70 in a distributed manner. Generally speaking, the host computer 20 is typically associated with a host and throughout this disclosure it is understood that a reference to a host user or a host implies actions and tasks undertaken by a user of the host computer 20. Similarly, the user/guest computer 90 is typically associated with a guest and/or user and throughout this disclosure it is understood that a reference to a guest user or a guest implies actions and tasks that may be undertaken by a user of the guest/user computer 90. The ticketing server system 80, the application server system 85 and the profile matching system 81 are also similarly referenced.

Briefly, the distributed computing system of FIG. 1 may provide a suitable environment to practice the invention. By way of an overview, a host, via the host computer 20 may coordinate the arrangement and purchase of tickets to an event by communicating with the application server system 85 and the ticketing server system 80. Further, the host may also create a profile (a description of a person's interests and characteristics) and request matches of other users' profiles by communicating with the profile matching system 81. Further yet, the host may communicate invitations to a guest/user via the guest/user computer 90. The guest/user may, in turn, be a host in different circumstances and may communicate with the application server system 85, the ticketing server system 80 and the profile matching system 81 in similar manner. Several embodiments of the invention are described below with reference to the context of the distributed computing environment of FIG. 1.

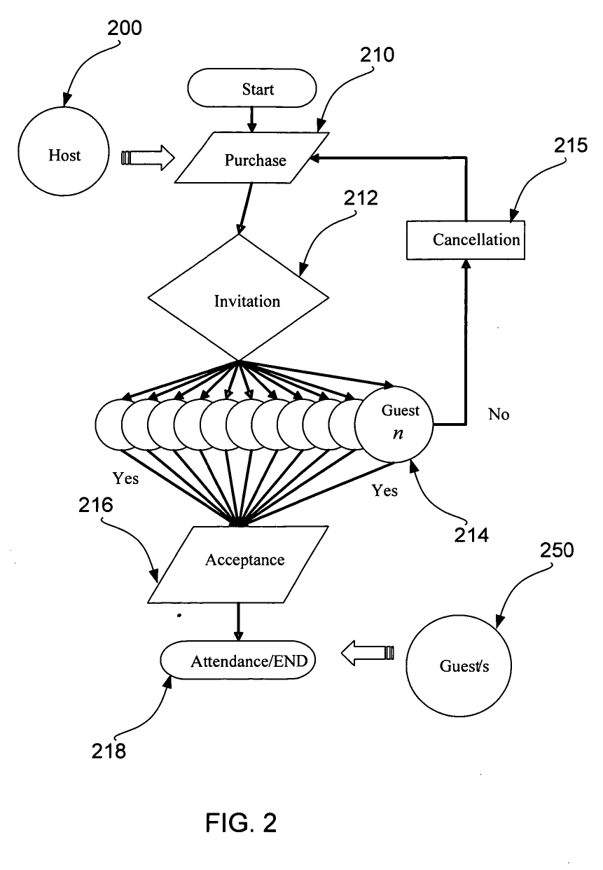

FIG. 2 is a flow chart of a method for an individual host to invite one or more guests by purchasing tickets and then verifying attendance according to an embodiment of the invention. In this embodiment, the method begins when a host 200 purchases, at step 210, two or more tickets via a ticketing server system. As discussed previously, the tickets may be purchased via a typical internet communication session between a host computer and a ticketing server computer. The tickets may be purchased outright by the host who may have previously made payment arrangements through the ticketing server system. Typically, the purchase will be arranged such that the ticket purchase may be cancelled or refunded if the host so indicates due to a lack of verification of attendance of invited guests (as is described further below). Furthermore, the payment arrangement established by the host may include an association to an account. The account may be a checking account, a credit card account, a rewards account, or any other type of financial or quasi-financial account that may be tracked and debited when a transaction is required. For the purposes of this embodiment, in step 210, the host 200 purchases a plurality of tickets to an event by debiting an associated account.

Next, at step 212, the host 200 may generate an invitation to the event indicating that the tickets to the event have already been purchased and that acceptance of the invitation by one or more of the invited guests will finalize the purchase and verify that the invited guest(s) plans to attend the event. The invitation may typically be in an email format and sent to one or more invited guests at step 214. Other forms of invitations are contemplated and include but are not limited to voice mail, text messaging, or any other electronic communication mechanism and/or protocol. Further, invitations may be sent and acceptances received via a paper invitation using a paper mail delivery system, such as the U.S. Postal Service.

Generally, one invitation per extra ticket purchased will be generated and sent to an invited guest. That is, the first ticket purchased is typically for the host and the next ticket purchased is associated with a first guest, the next ticket purchased is associated with a second guest, and so on. As such, each invited guest will receive a communication (step 214) indicating that a ticket to the event has been purchased by the host 200 and that the particular invited guest 250 may respond with an affirmative or a negative response as to whether the invitation will be accepted. If an invited guest 250 declines the invitation, then at step 215, a cancellation notice may be communicated to both the host 200 and to the ticketing server computer, such that the purchased ticket associated with the invited guest is returned and/or refunded. However, if the invited guest 250 accepts the invitation, then both the host 200 and the ticketing server computer are notified and of the acceptance of the invitation, thereby removing any pending status that may be associated with the particular purchased ticket.

Once each invited guest 250 has responded, then all accepted invitations are verified as attendance at step 218. The method may also include a provision to arrange tickets such that after all invited guests have responded, and then any tickets that need to be cancelled are done so in a preferred order. For example, if ten tickets are purchased for guests 1-10, but only five guests (guests 1, 3, 5, 7, and

9) accept the invitation, then five tickets may be returned corresponding to seats 6-10 (as opposed to seats 2, 4, 6, 8, and 10). In this manner, attending guests and the host may sit together which is typically preferable. In a different embodiment, the host may choose to send invitations to an additional five people that may even be designated as another group, (i.e., office group vs. neighborhood friends).

The event for which tickets are being arranged may be any possible event that typically requires special arrangements for admission. Some examples of such events may include, but are not limited to, sporting events, concerts, trade shows, festivals, club meetings, movies, theatre shows, hotel packages, vacation packages, travel, car rentals, marketing events, rewards programs, redeemable vouchers, job interviews, and the like. Special arrangements may typically be a ticket or fee required for attendance, but may also be other kinds of transactions, such as redemption of reward points, a binding to accept a offer (a credit card offer, for example), or just about any other arrangement in which the guest(s) accepting the invitation is subject to an agreement upon accepting the invitation. Generally speaking, a host may invite guests to an event whereby the acceptance of the invitation invokes the acquisition of the means for attending the event via some transaction.

The methods and systems may be applicable to a number of hosting situations. In an obvious example, a host 200 may easily coordinate purchasing tickets and attending an event, such as a football game, involving a group of friends. In a different manner a host 200 may wish to offer to take a user/guest 250 on a date by extending an invitation that includes purchasing tickets to a concert.

In a more commercial setting, a host 200 may be a company that uses a commercial rewards system to promote customer loyalty. Thus, the company may be the host 200 that may send an invitation to a guest 250 (a buyer of their product) using the system so that they could receive free tickets to an event that the company is “hosting” thereby paying for the ticket(s).

Still further yet, a host company 200 may implement a marketing system within the context of the invention. In this manner, the host company 200 may entice known buyers/users of their products with free tickets for those users to utilize as they wish. The assumption is that the enticed users, acting as hosts, would give them to people they felt would enjoy them and could then be a way of increasing the exposure of the company/product to new buyers (i.e., movie tickets to increase buzz, etc.) or building a user community thereby promoting product sales.

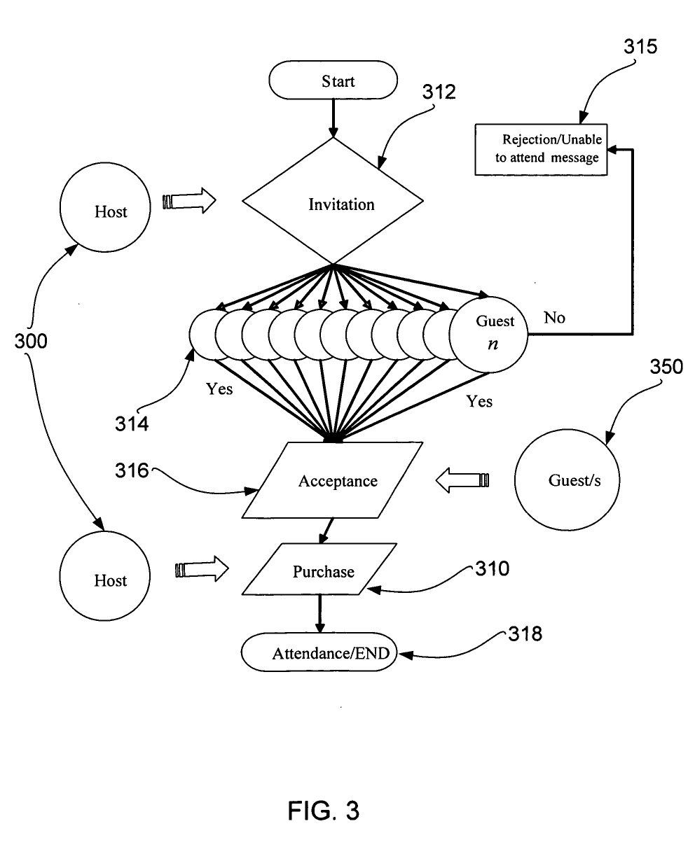

The embodiment of FIG. 2 places the payment arrangements at the discretion solely of the host 200. That is, the host controls the purchase of the tickets, payment coordination (i.e., credit card or bank account), and preferences for cancellation and the like. However, other arrangements may be made such that payments for tickets may be arranged by the invited guests themselves. Such a method is described in FIG. 3.

FIG. 3 is a flow chart of a method for an individual host to invite one or more guests by reserving one or more tickets and then arranging for the purchase after verifying attendance according to an embodiment of the invention. In this embodiment, the method begins when a host 300 reserves (as opposed to outright purchasing), at step 310, two or more tickets via a ticketing server system. The reservations may include a time frame by which a purchase must occur or the reservation is lost. The host 300 may also make arrangements to pay a nominal fee for longer reservation times or last-minute reservations. Additionally, the time frame may be variable depending on the event, the amount of time until the event, the nature of the tickets being reserved, etc.

Next, at step 312, the host 300 may generate an invitation to the event indicating that the tickets to the event have been reserved and that acceptance of the invitation on behalf of one or more invited guests will enable the host 300 to proceed further with the reservations. Thus, at step 314, each invited guest 350 is notified of the invitation via a communication. At step 316, each invited guest 350 has an opportunity to accept or decline the invitation. If the invitation is accepted, the host 300 is then notified and given an opportunity to purchase the tickets for all accepted invitations at step 310. If any invitation is declined, the host and/or the ticketing server computer may be notified at step 315.

In one payment arrangement, a host 300 may purchase one ticket (his/her own ticket) initially (at step 312) and is given the option to purchase the additional tickets that correspond to each accepted invitation (at step 310). Alternatively, the host 300 may choose to simply be notified of each acceptance and be given an opportunity to pay for all tickets (including his/her own) after all invited guests have responded and before a time frame for responding has expired. Once the purchase has concluded at step 310, the host 300 and guests may attend the event at step 318.

Generally, as before, one invitation per extra ticket reserved will be generated and sent to an invited guest. That is, the first ticket reserved is typically for the host 300 and the next ticket reserved is associated with a first guest, the next ticket purchased is reserved with a second guest, and so on. As such, each invited guest will receive a communication (step 314) indicating that a ticket to the event has been reserved by the host 300 and that the particular invited guest 350 may respond with a yes or no as to whether the invitation will be accepted. If an invited guest 350 declines the invitation, then at step 315, a cancellation notice may be communicated to both the host and the ticketing and application server(s) 300. Similarly, all other invited guests may also respond in kind. When all invitations are responded to (or have timed out) any reserved tickets associated with invited guests that have declined the invitation may be released. However, if one or more of the invited guests 350 accept the invitation, then both the host 300 and the ticketing server computer may be notified of the invitation acceptance and the host's 300 subsequent payment for the ticket, thereby removing any pending status associated with the particular purchased ticket.

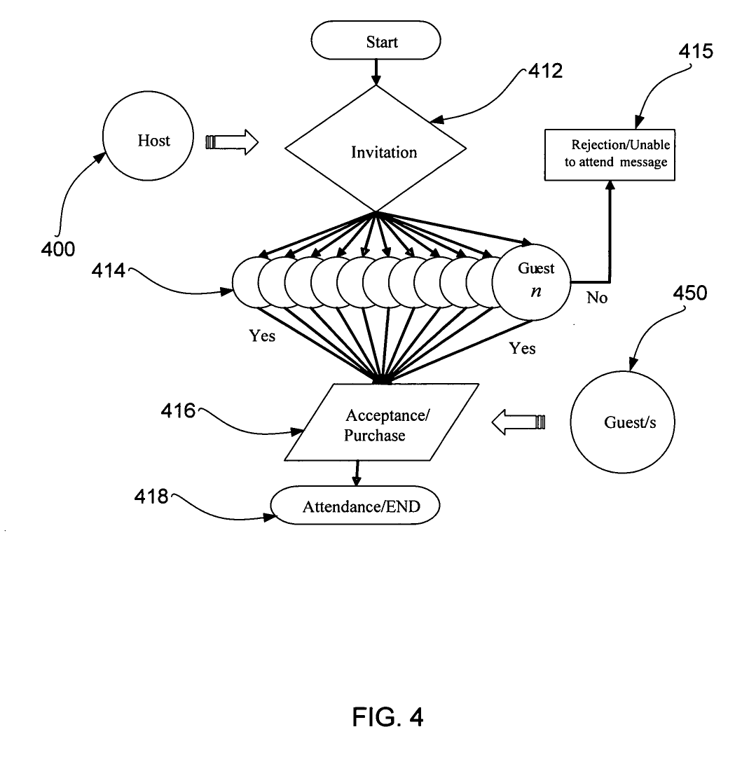

In yet another embodiment, each invited guest may be given an opportunity to arrange for ticket payment instead of relying upon the host 300 as described below in FIG. 4.

FIG. 4 is a flow chart of a method for an individual host to invite a plurality of guests by reserving tickets and then enabling each invited guest to purchase a ticket upon verification of attendance according to an embodiment of the invention. In this embodiment, the method begins when a host 400 reserves, at step 410, two or more tickets via a ticketing server system. The reservations may again include a time frame by which a purchase must occur or the reservation is lost. Next, at step 412, the host 400 may generate an invitation to the event to be delivered to each invited guest at step 414. The invitation generally indicates that the tickets to the event have been reserved and that acceptance (at step 416) of the invitation on behalf of one or more invited guests will enable each particular invited guest an opportunity to purchase their own ticket for the event. Any rejection of an invitation may be communicated back to the host 400 and/or the ticketing computer system at step 415.

Typically, a host 400 may arrange for payment of their own ticket to be executed if and when one or more guest also accepts the invitation and subsequently pays for their own ticket. Alternatively, the host 400 may set up the invitation such that acceptance of the invitation by an invited guest 450 is an offer to pay for the particular invited guest 450 as well as the host 400. Several other variations are envisioned, such as one invited guest 450 may choose to purchase all tickets for accepted invitations or that each invited guest 450 that accepts the invitation may pay for their own ticket as well as a specific or proportional amount of another's ticket, such as the host 400 ticket. Once all invited guests 450 and the host 400 are accounted for, the method ends with attendance of confirmed and ticket-holding individuals at step 418.

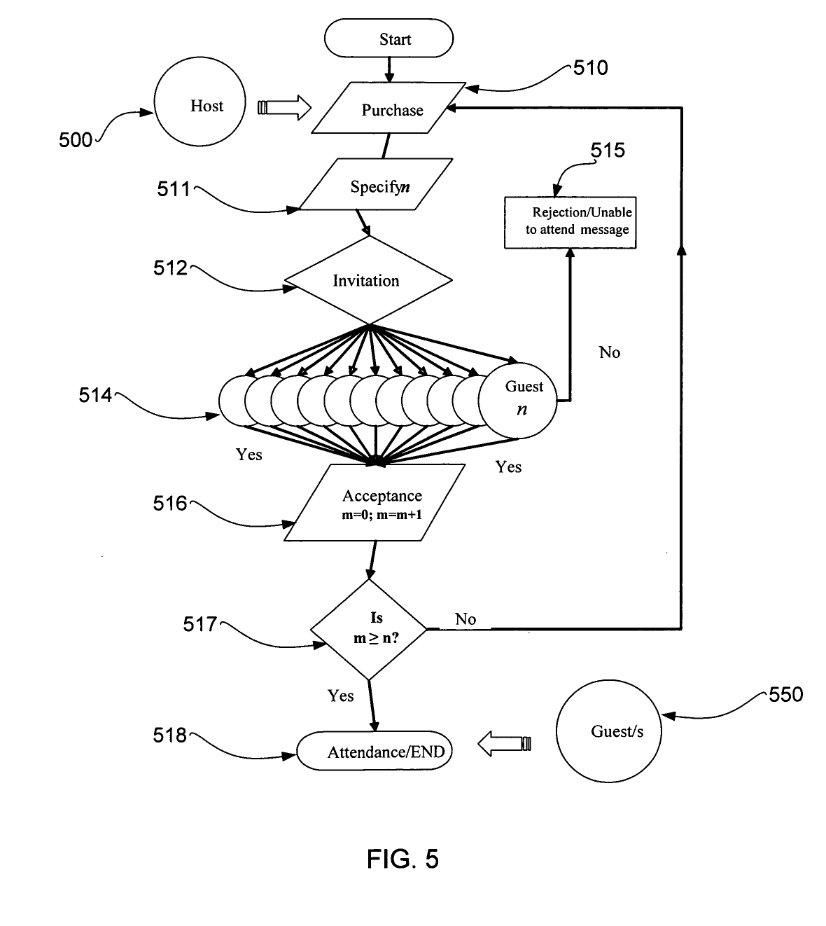

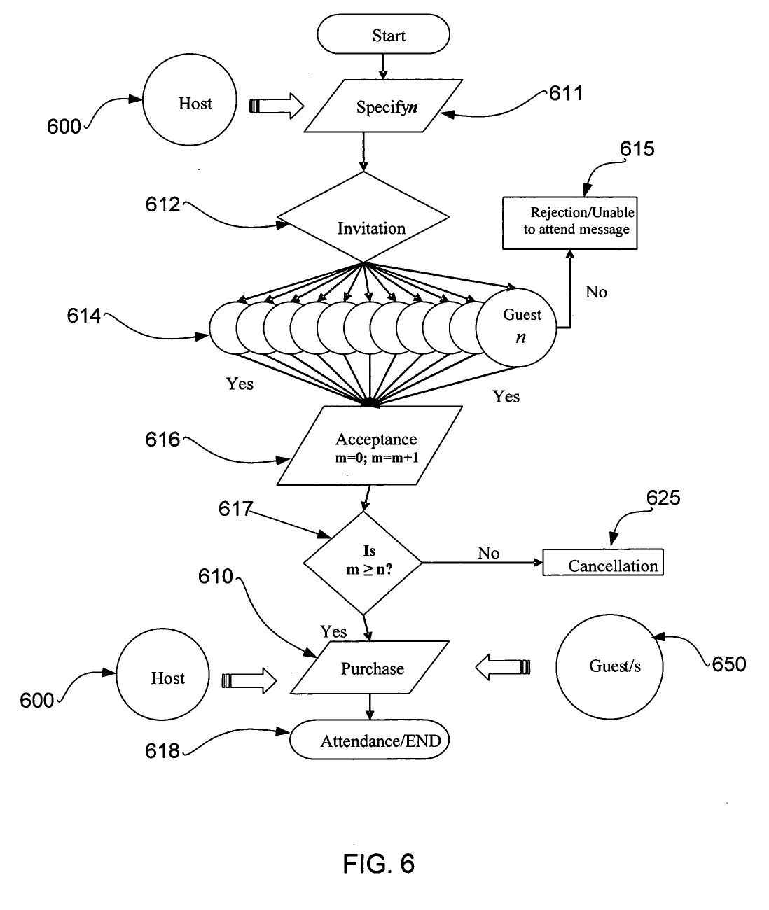

Additional embodiments allow for an arrangement to be made such that a threshold number of guest must accept an invitation before any tickets are purchased. Further, a particular guest may be designated as necessary to attend prior to purchasing any tickets. FIGS. 5 and 6 are examples of a threshold attendance embodiment of the invention.

FIG. 5 is a flow chart of a method for an individual host to invite one or more guests by purchasing tickets and then verifying an attendance threshold according to an embodiment of the invention. In this embodiment, the host 500 may arrange for the purchase of a group of tickets to an event at step 510. Then, the host 500 may specify a threshold number that is an indication of the minimum or maximum number of invited guests that must accept the invitation in order for the purchase of tickets to move forward. As such, the host 500 specifies the threshold attendance value at step 511 and then generates an invitation at step 512. The invitation is then communicated to each invited guest 550 at step 514.

As invited guests respond, accepted invitations may generate a notification to the host 500 and may increment a threshold counter at step 516. Declined invitations may also generate a notification to the host 500 and/or the ticketing server computer at step 515. For example, a host 500 may wish to attend a jazz concert, but only if three friends go with the host 500. Thus, the host 500 may invite five people in hopes of three accepting the invitation. Once all invited guests 550 respond and/or a specific time frame expires, the accepted invitation count is compared to the threshold attendance value at step 517. If enough invited guests 550 respond affirmatively, then the appropriate number of tickets remain purchased and all ticketed individuals may attend the event at step 518. However, if the threshold attendance is not met (i.e., not enough invited guests 550 accept the invitation) then all purchased tickets may be cancelled and refunded by notifying the host 500 and/or the ticketing server computer. The host 500 may also have the option of purchasing the balance tickets.

In another embodiment, the host 500 may arrange for the threshold attendance to be a cutoff attendance. For example, the host 500 may wish to attend a square dancing competition, but only if seven additional invited guests accept the invitation to ensure a full group for square dancing. Once seven additional invited guests have accepted an invitation to a square dancing competition, additional invited guests may not be allowed to accept an invitation or buy tickets. Thus, the host 500 may arrange for the threshold to be a cutoff, such that the purchased tickets are available on a first-come-first-serve basis. If seven additional tickets are purchased, then the first seven invited guests to accept the invitation get the tickets and any additional invited guests may no longer accept the invitation since there is no ticket available if they did. In the case where the cut off threshold is not met, the host has the option to purchase the balance tickets.

In yet another embodiment, the host 500 may arrange for a threshold attendance, but purchase tickets above and beyond the threshold. The host 500 may make additional arrangements to return extra tickets while still keeping the threshold number of tickets. As such, if the threshold is met, the tickets for the accepted invitations remain purchased, but extra tickets may be returned for a refund. For example, a host 500 may wish to invite guests to a basketball game, but only if five friends can go. The host 500 may purchase ten tickets in hopes of having ten friends attend, but set up the threshold at five accepted invitations. Then, seven friends may accept the invitation. Thus, the host 500 has already purchased ten tickets, but now only needs seven. The three extra tickets may be returned and refunded.

In yet another embodiment, the host 500 may specify a customized threshold attendance such that specific invited guests must accept the invitation in order to satisfy the threshold requirement. For example, a host 500 may want to arrange a birthday gift for Bill wherein Bill and several friends go to a baseball game. The host may set the threshold at five guests plus Bill such that if not enough invited guests accept the invitation or if Bill, himself, does not accept the invitation, then the purchased tickets may be cancelled.

In another embodiment, the host 500 may assign ratings to each invited guests and set a threshold attendance rating for the event to occur. Thus, the host 500 may assign higher ratings to certain guests that take into account their relative importance to the particular event. For example, a host 500 may be organizing the purchase of tickets to a swing dancing event, but may wish to assign higher ratings to invited guests known to be swing dancers. As such, if enough higher-rating invited guests accept the invitation and the threshold attendance rating is reached (i.e., enough swing dancers along with some non-swing-dancers), then the ticket purchase may be maintained.

FIG. 6 is a flow chart of a method for an individual host to invite one or more guests by reserving one or more tickets and then purchasing after verifying attendance according to an embodiment of the invention. Similar to the methods described above with respect to FIGS. 3 and 4, the host 600 may reserve tickets in order to verify attendance before purchase. In this embodiment, the host 600 may, at step 611, reserve a specific number of tickets and specify a threshold number that is an indication of the minimum number of invited guests 650 that must accept the invitation in order to complete the purchase. As such, the host specifies the threshold attendance value at step 611 and then generates an invitation at step 612. The invitation is then communicated to each invited guest 650 at step 614.

As invited guests respond, accepted invitations may generate a notification to the host 600 and may increment a threshold counter at step 616. Declined invitations may also generate a notification to the host 600 and/or the ticketing server computer at step 615. Once all invited guests 650 respond and/or a specific time frame expires, the accepted invitation count is compared to the threshold attendance value at step 617. If enough invited guests 650 respond affirmatively, then the tickets may be purchased, at step 610, either by the host 600 or by each invited guest 650 individually, or some combination thereof. Once tickets are purchased, all ticketed guests may attend at step 618. However, if the threshold attendance is not met (i.e., not enough invited guests 650 accept the invitation) then all purchased/reserved tickets may be cancelled and refunded by notifying the host 600 and/or the ticketing server computer. The host 600 may also have the option of purchasing the balance tickets.

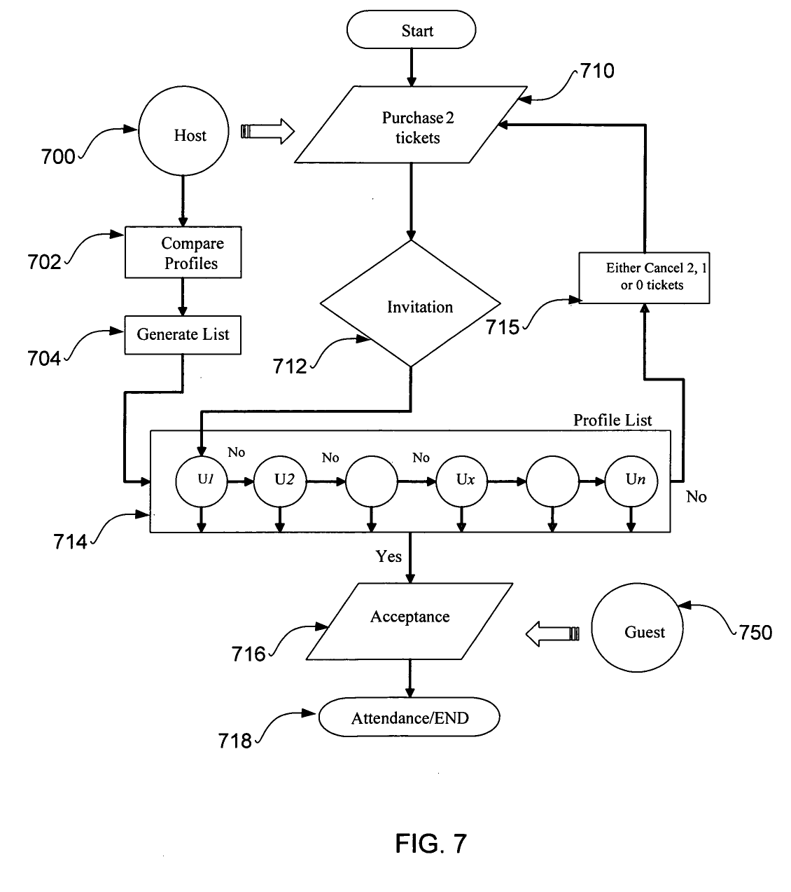

The preceding examples and embodiments of the invention are described in the context of the host knowing the invited guests and specifically choosing which invited guests to include in any event invitation. The invention may also be practiced in an environment in which the host may not know the invited guest(s) directly. For example, there are several versions of a profile matching system through which users can initiate an introduction or meeting of a person or people that the user does not know. Such profile matching systems and introduction methods are known in the art and may be used in conjunction with the invention. In particular, the previous methods described above may be used as a model for providing a user of one of these profile matching systems the ability to coordinate, organize, and distribute the means of attending an event, an example of which includes but is not limited to the act of purchasing tickets for a ticketed event. FIGS. 7-17 depict flowcharts of various embodiments of these methods.

FIG. 7 is a flow chart of a method for an individual host to invite one or more hidden guests through matching profiles of potential invited guests by purchasing tickets and then verifying attendance according to an embodiment of the invention. As used herein, a “hidden” guest or guests is a term used to refer to individuals using the system that are associated with user profiles that are not allowed to be accessed by a host. Thus, the profile is hidden to the user. The method may be practiced within the context of a profile matching system wherein a host 700 is associated with a user profile that typically describes specific characteristics, interests, and personal information about the host 700. As is typically the case, several other users of the profile matching system are also associated with their own respective profiles. As such, several permutations of a matching algorithm may produce different correlations between all users. For example, several users may indicate that baseball is an interest. Thus, the profile matching system may be configured to identify all users with baseball interests should a particular user request this information. The nature of operation of the profile matching portion of method need not be discussed further as various profile matching methods and algorithms are well known in the art.

In the embodiment of FIG. 7, the host 700 may wish to invite an unknown user to an event and offer to pay for the tickets. The host 700 may initiate this process by requesting a comparison of all profiles in a profile matching system at step 702. The profile matching system may generate a matching profile list at step 704. The host 700 may, at the same time, purchase a quantity of tickets, at step 710, to an event in anticipation of a number of the matched users accepting an invitation. Thus, an invitation is generated at step 712 that will reference the purchased tickets and the event and will be sent to at least one user in the generated list of matches provided by the profile matching system.

The matching profile list may not be seen by the host 700 in this embodiment. That is, the matching profile list is hidden and invitations to users associated with the matching profiles in the list will be done so according to a profile matching algorithm that is not within the control of the host 700. Other embodiments allow the host 700 to see the matching profile list and are described further below. For this embodiment, however, the matching profiles remain hidden from the host 700.

The invitation may be communicated to users with a matching profile that was generated in response to the request for profile matches in step 714. The communications may be done in an iterative manner. That is, the first user U1 in the list (which typically corresponds to the best profile match) may be sent an invitation and time to respond first. If the first user U1 declines the invitation or does not respond within a specified time, the second user U2 may receive a communication detailing the invitation from the host 700 and be given the same opportunity to accept or decline within a specified time. If an invited guest (i.e., one of the matched users U1-Un) accepts the invitation in response to a received communication, then the method proceeds to step 716 where the invitation to the event is confirmed. The host 700 and/or ticketing server computer may be notified and the host 700 and the particular invited guest 750 that accepted the invitation may attend the ticketed event at step 718. If, however, no user U1-Un accepts the invitation, a cancellation notice may be sent to the ticketing server computer and the host 700 may be notified at step 715.

Although described as an iterative process for communicating invitations to the matched users, the host 700 may arrange for any number of different invitation methods. Further, the order of the list may be specified by the host or by the profile matching system. For example, in one ordering scheme, the profiles with highest number of matching parameters are listed first, while profiles with fewer matching parameters are listed further down the list. Alternatively, an ordering scheme placing particular emphasis on one parameter over others may also be used to order the matches differently. Again, methods associated with the profile matching system are well known and are not discussed in detail herein.

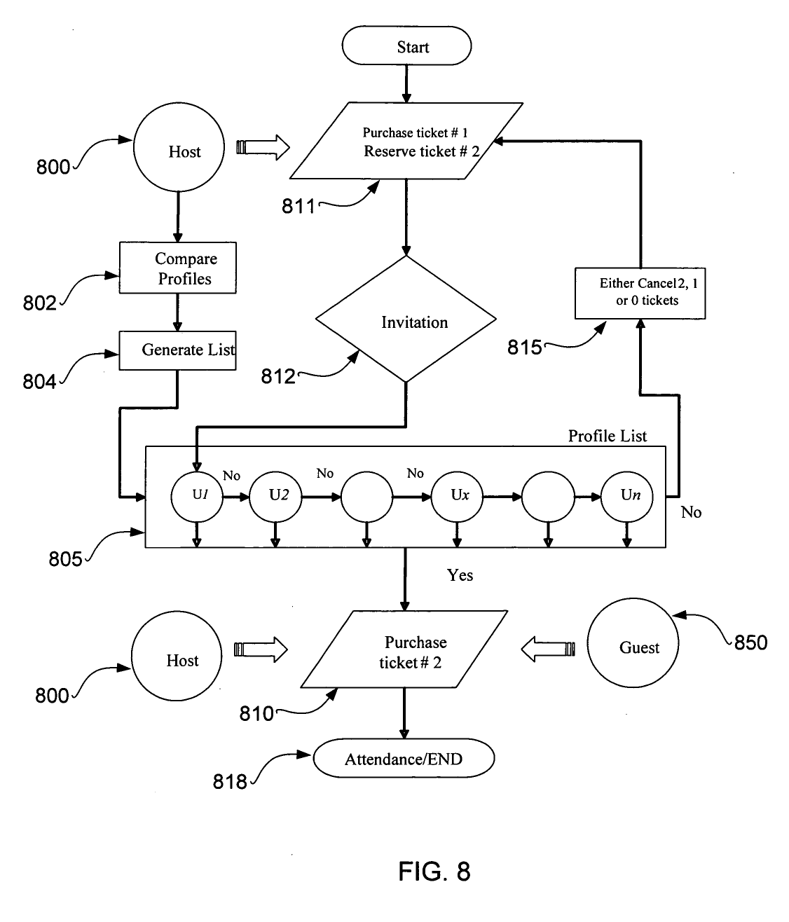

Further, the method shown in FIG. 7 may also be substantially similar but allow for the invited guest to purchase their ticket or both. This method is described in FIG. 8.

FIG. 8 is a flow chart of a method for an individual host to invite one or more hidden guests through matching profiles of potential invited guests by reserving one or more tickets and then purchasing after verifying attendance according to an embodiment of the invention. In this embodiment, the host 800 again may wish to invite an unknown user to an event but, in this case, not offer to pay for both tickets. The host 800 may again initiate this process by requesting a comparison of all profiles in the profile matching system at step 802. The profile matching system may generate a matching profile list at step 804. The host 800 may, at the same time, purchase one ticket and reserve one ticket, at step 811, to an event in anticipation of one of the matched users accepting an invitation and paying for their own ticket. Alternatively, the host may reserve two tickets, at step 811, in anticipation of an invited guest accepting an invitation to pay for both tickets. For example, there may often be the case in which one spouse makes all arrangements and then the other spouse actually purchases the tickets as a ‘surprise gift’. In either case, an invitation is generated at step 812 that will reference the purchased/reserved tickets and the event and will be sent to at least one user in the generated list of matches provided by the profile matching system.

Again, the matching profile list is not able to be seen by the host 800 in this embodiment because the matching profile list is hidden and invitations to users associated with the matching profiles in the list will be done so according to a matching algorithm that is not within the control of the host 800. The invitation may be communicated to each user U1-Un with a matching profile that was generated in response to the request for profile matches in step 814. The communications may be done so in an iterative manner. That is, the first user U1 in the list may be sent an invitation and time to respond first. If the first user U1 declines the invitation or does not respond within a specified time, the second user U2 may receive a communication detailing the invitation from the host 800 and be given the same opportunity to accept or decline within a specified time. If an invited guest (i.e., one of the matched users U1-Un) accepts the invitation in response to a received communication, then the method proceeds to step 810 where the invitation to the event is confirmed by the invited guest arranging for the purchase of the second ticket (or both). Then, the host 800 and/or ticketing server computer may be notified and the host 800 and the particular invited guest 850 that accepted the invitation may attend the ticketed event at step 818. If, however, no user U1-Un accepts the invitation, a cancellation notice may be sent to the ticketing server computer and the host may be notified at step 815. Thus, any reservation of a ticket may be cancelled and any purchase of a ticket may be refunded.

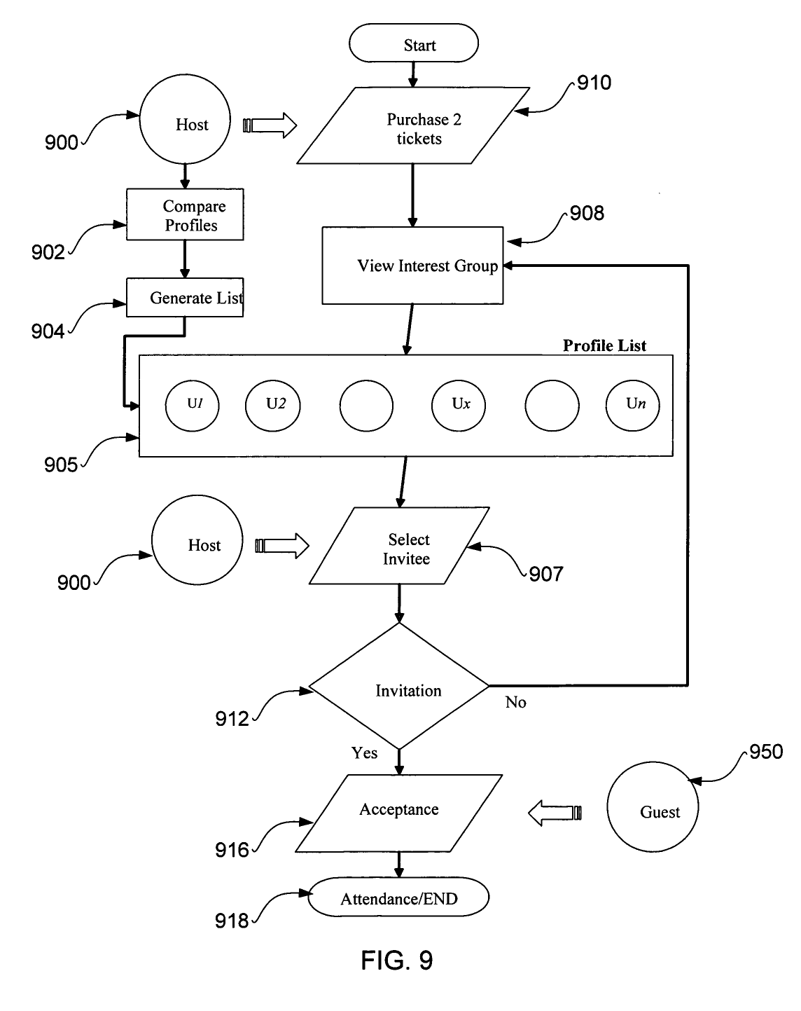

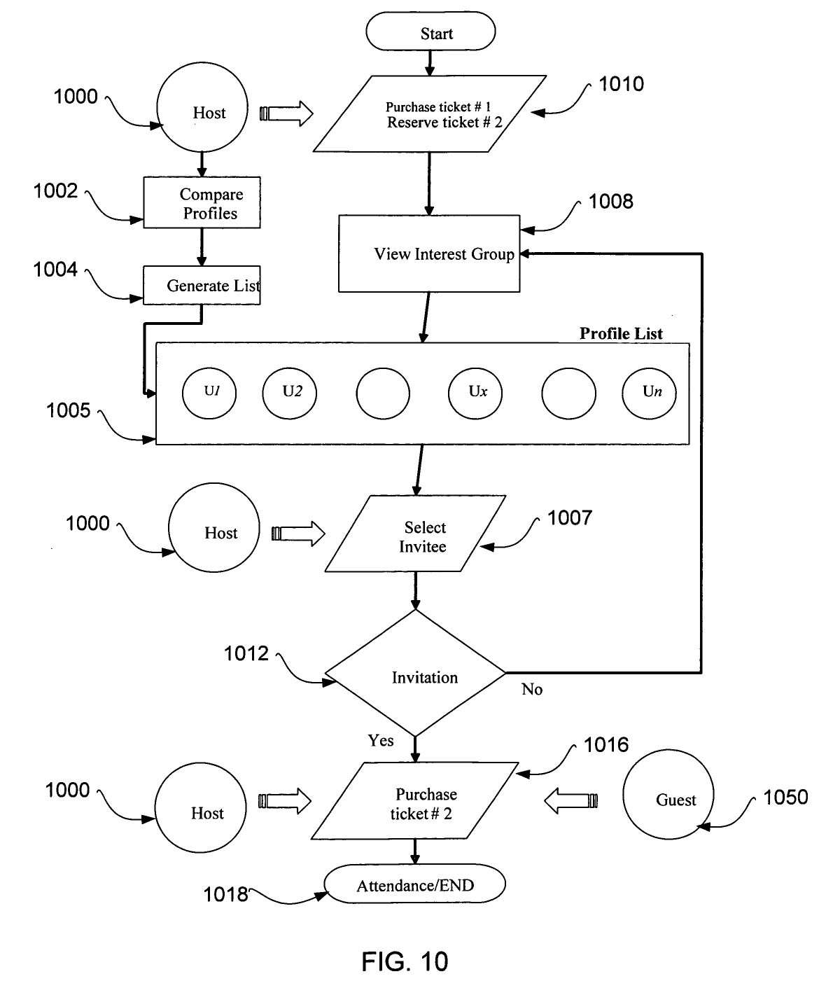

In an alternative to the previous two embodiments of FIGS. 7 and 8, the host may have an additional opportunity to view and choose among matching profiles with the profile matching system. As such, the host may, in fact, see the profile matches and select among them when generating invitations to events. FIGS. 9 and 10 show flowcharts for these embodiments of the invention.

FIG. 9 is a flow chart of a method for an individual host to invite one or more guests by selecting among the profiles generated by a matching algorithm, purchasing tickets and then verifying attendance according to an embodiment of the invention. In this embodiment, the host 900 may wish to initiate a profile match to determine a list of potential invited guests and then choose among the identified matches. Further, the host 900 may wish to offer to pay for both tickets. The host 900 may initiate this process, as was the case above, by requesting a comparison of all profiles in the profile matching system at step 902. The profile matching system may generate a matching profile list at step 904. The host 900 may, at the same time, purchase two tickets, at step 910, to an event in anticipation of one of the matched users accepting an invitation.

However, instead of sending an invitation to the first matching profile in the list, the host 900 is given an opportunity to view the list of matching profiles at step 908 and then rank the list 905 of profiles (at step 907) that will receive an invitation to the event. Thus, an invitation is generated at step 912 that will reference the purchased tickets and the event and will be sent to the user associated with the highest rated profile. The selected invited guest 950 may choose to accept the invitation at step 912, thereby initiating a notification to the host 900 and the ticketing server computer indicating the acceptance of the invitation. Thus, the tickets initially purchased by the host at step 910 may be verified and the attendance happens at step 918. If, however, the first invited user declines the invitation, the user associated with the next highest ranked profile user associated with the next highest ranked profile will be given the option (via a communicated invitation) to accept or decline the invite. If all invited guests decline the invitation, the host 900 and the ticketing server computer may be notified and the purchased tickets may be cancelled and refunded.

Similarly, FIG. 10 is a flow chart of a method for an individual host to invite one or more guests through matching profiles of potential guests by selecting among the profiles, reserving one or more tickets, and then purchasing after verifying attendance according to an embodiment of the invention. In this embodiment, the host 1000 may wish to initiate a profile match to determine a list of potential guests and then choose among the identified matches. Further, the host 1000 may wish to only reserve the tickets initially or purchase one and invite the guest to purchase the second ticket. The host 1000 may initiate this process, as was the case above, by requesting a comparison of all profiles in the profile matching system at step 1002. The profile matching system may generate a matching profile list at step 1004. The host 1000 may, at the same time, purchase one ticket and reserve one ticket, at step 1010, (or reserve both) to an event in anticipation of one of the matched users accepting an invitation.

However, again instead of sending an invitation to a first matching profile in the list, the host 1000 is given an opportunity to view the list of matching profiles at step 1008 and then rank the list 1005 of profiles (at step 1007) in the order in which they will receive an invitation to the event. Thus, an invitation is generated at step 1012 that will reference the purchased/reserved tickets and the event and will be sent to the user associated with the highest ranked profile. The invited guest 1050 may choose to accept the invitation at step 1012, thereby initiating a notification to the host 1000 and the ticketing server computer indicating the acceptance of the invitation. Thus, the tickets initially reserved by the host at step 1010 may be purchased by the invited guest at step 1016 and attendance happens at step 1018.

Again, however, if the first invited user declines the invitation, user associated with the next highest ranked profile will to the user associated with the next highest ranked profile will be given the option (via a communicated invitation) to accept or decline the invite. If all invited guests decline the invitation, the host 1000 and the ticketing server computer may be notified and the purchased/reserved tickets may be cancelled and/or refunded.

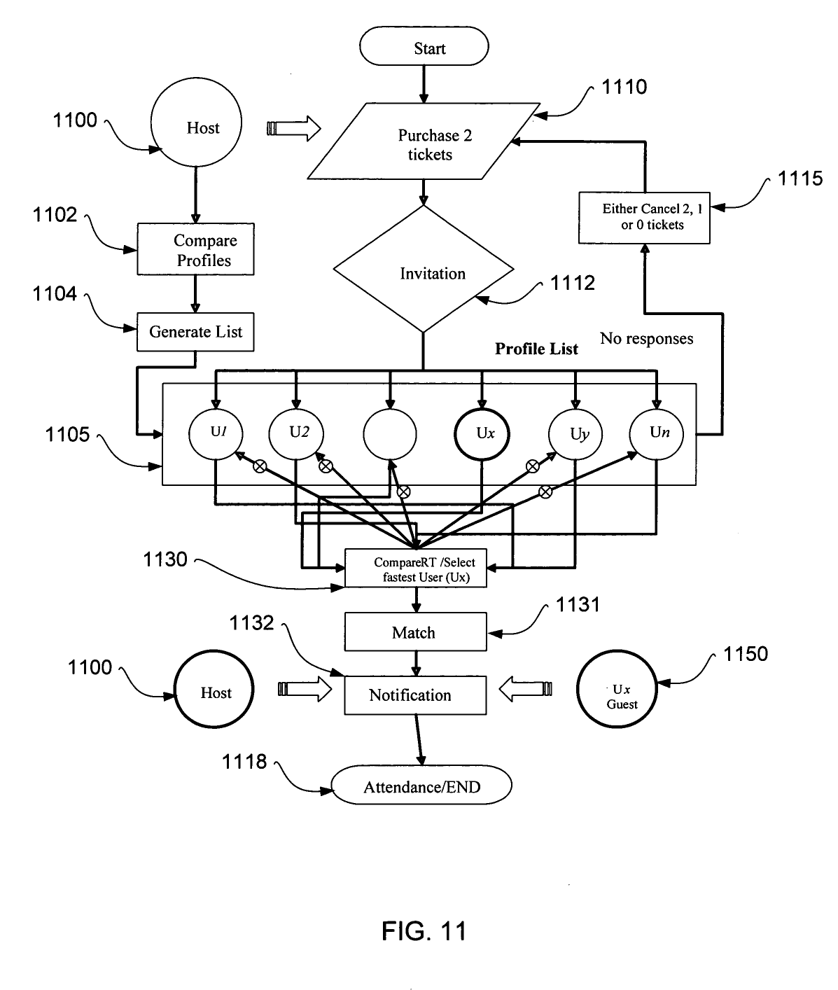

FIG. 11 is a flow chart of a method for an individual host to invite one or more guests through matching profiles of potential guests by purchasing tickets and then verifying attendance of the first responding guest to accept the invitation according to an embodiment of the invention. In this embodiment, similar to FIG. 9, the host 1100 may wish to initiate a profile match to determine a list of potential guests and then choose among the identified matches. Further, as before, the host 1100 may wish to offer to pay for both tickets. The host 1100 may initiate this process, as was the case above, by requesting a comparison of all profiles in the profile matching system at step 1102. The profile matching system may generate a matching profile list at step 1104. The host 1100 may, at the same time, purchase two tickets, at step 1110, to an event in anticipation of one of the matched users accepting an invitation.

In this embodiment, all users with matching profiles may receive an invitation (step 1112) that references the purchased tickets and the event. Then, the first user to accept (for example, user Ux) the invitation becomes the guest 1150. Thus, at step 1130, the first response among the matching users is determined. In this embodiment, the host 1100 may have an opportunity to accept or decline the fastest respondent at step 1131. If accepted, then each user, (the host 1100 and the guest 1150) are notified along with the ticket server computer and the purchased tickets are verified. Once verified, attendance may occur at step 1118. As before, if all users associated with the matching profile decline the invitation, the host 1100 and the ticketing server computer may be notified and the purchased tickets may be cancelled and refunded, at step 1115.

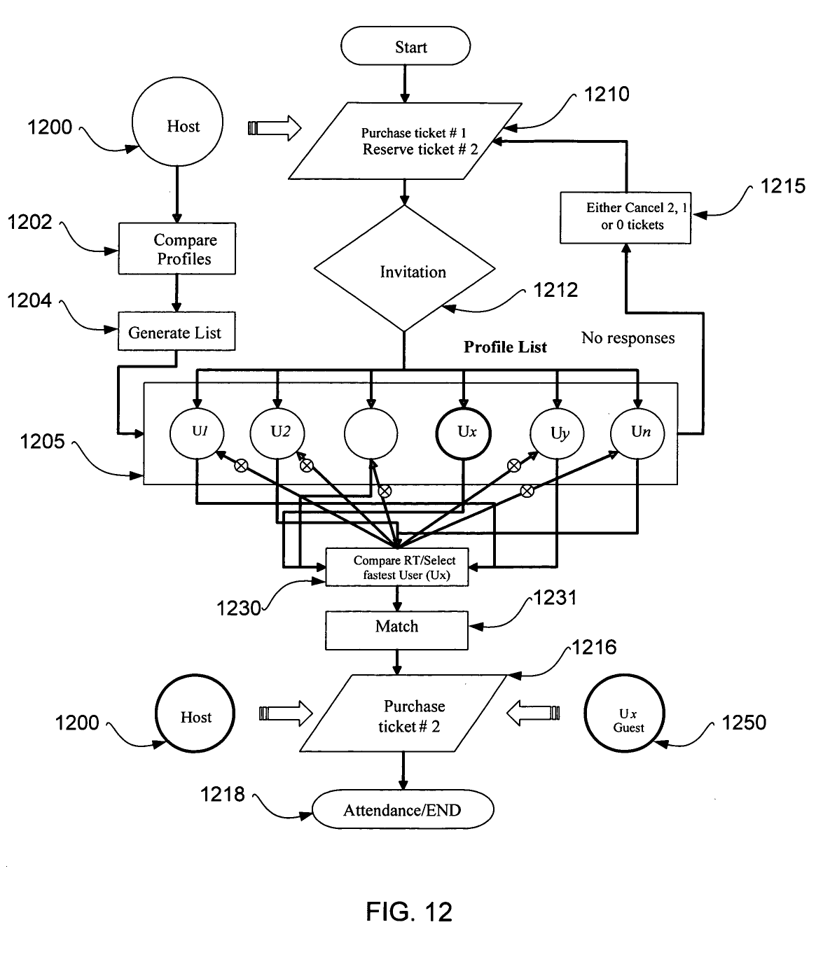

Similarly, FIG. 12 is a flow chart of a method for an individual host to invite one or more guests through matching profiles of potential guests by reserving one or more tickets and then purchasing after verifying attendance of the first responding guest to accept the invitation according to an embodiment of the invention. In this embodiment, the host 1200 may wish to initiate a profile match to determine a list of potential invited guests and then choose among the identified matches. The host 1200 may initiate this process, as was the case above, by requesting a comparison of all profiles in the profile matching system at step 1202. The profile matching system may generate a matching profile list at step 1204. The host 1200 may, at the same time, purchase one ticket and reserve one ticket, at step 1210, (or reserve both) to an event in anticipation of one of the matched users accepting an invitation.

In this embodiment, all matching profiles 1205 may receive an invitation (step 1212) that references the purchased/reserved tickets. Then, the first user to accept (for example, user Ux) the invitation becomes the invited guest 1250. Thus, at step 1230, the user with the fulfilling criteria (e.g., the fastest response among the matching users) is determined. In this embodiment, the host 1200 may have an opportunity to accept or decline the match (e.g., fastest respondent) at step 1231. If accepted, then each user, (the host 1100 and the invited guest 1250) are notified along with the ticket server computer and the reserved tickets are purchased. This also may be the step in which the invited guest arranges for the purchase of one or both tickets. Once verified, attendance may occur at step 1218. As before, if all users associated with the matching profile decline the invitation, the host 1200 and the ticketing server computer may be notified and the purchased tickets may be cancelled and refunded, at step 1215.

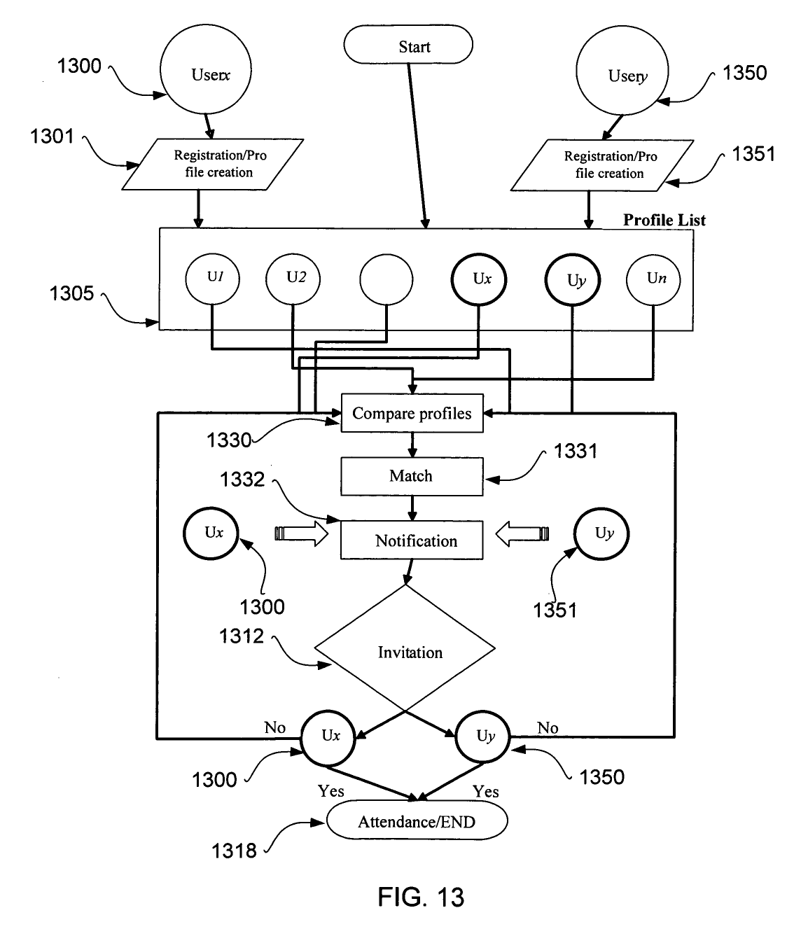

FIG. 13 is a flowchart of a method for enabling users of a matching profile system to request a match and the arrangement for the purchase of tickets based on a verification of attendance to an event. In this embodiment, a User X 1300 and a User Y 1350 may wish to explore some possibilities for attending a particular event. This method may be synonymous with a “singles area” such that users may enter and or submit a user profile as well as an interest in a particular event and then request matches to see if another user is willing to attend under matching circumstances. Thus, User X 1300 may submit a profile at step 1301 and User Y 1350 may also do likewise at step 1351. These profiles, as well as several others (U1-Un) may be submitted to a profile list 1305 such that the profile matching system seeks to match similar interests and events.

At step 1330, the matching profile system may compare all profiles in the profile list 1305 and generate a best match at step 1331. At this point, User X 1300 and User Y 1350 may be each notified of the match at step 1332. Then, either user 1300/1350 may initiate an invitation at step 1312. The invitation may be an offer to purchase both tickets, an offer to purchase one if the other user purchases one, or an offer to attend if the other user purchases both tickets. This invitation is communicated to the recipient and the recipient may respond with an acceptance of the invitation at which point the arrangements for payment for the tickets is executed (i.e., one user or both pay for the ticket upon acceptance of the invitation) according to the nature of the invitation. Thus, both users 1300/1350 attend the event at step 1318. If one user, however, declines the invitation, both users may be returned to a profile matching step and the process may be repeated until an accepted invitation is reached or there are no longer any matches in the profile list 1305.

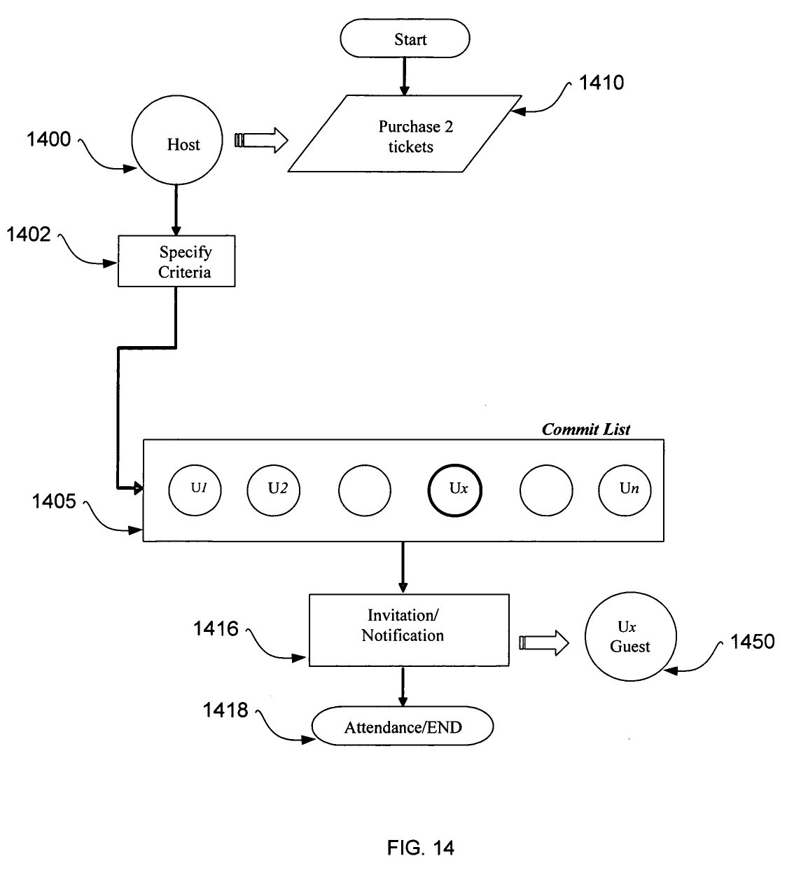

In other embodiments of the invention, a user may indicate a commitment to attend an event if a suitable invitation was made. Thus, a committed user is essentially expressing expressing interest to go to an event. Various permutations of this embodiment are described in FIGS. 14-18 below.

FIG. 14 is a flow chart of a method for a committed guest be chosen for an invitation from a host who requests a profile match of potential guests, wherein the host purchases the tickets prior to initiating the invitation. In this embodiment, a host 1400 may specify criteria (1402) to generate a list of committed users 1405 that have indicated to the system that they are willing to accept an invitation to one or more events from any host 1400 that may initiate an invitation.

The host 1400 may purchase two tickets (15410) to an event and let the profile matching system determine the best match among committed users (U1-Un). An invitation is communicated to the user (U1) associated with the best-matching profile and the first committed user (U1) typically is subject to automatically accepting the invitation and subsequently notified (1416) that their committed user status has yielded an invitation from a host 1400 that has already purchased tickets thereby becoming the invited guest 1450 for attendance 1418.

In other embodiments described below, the committed users (U1-Un) may enable the automatic acceptance of any matching invitation. In other embodiments, the committed user may choose to accept the invitation and/or even purchase the tickets, Thus, in a committed user situation, the arrangement that the host purchase both tickets is not necessarily required as described below.

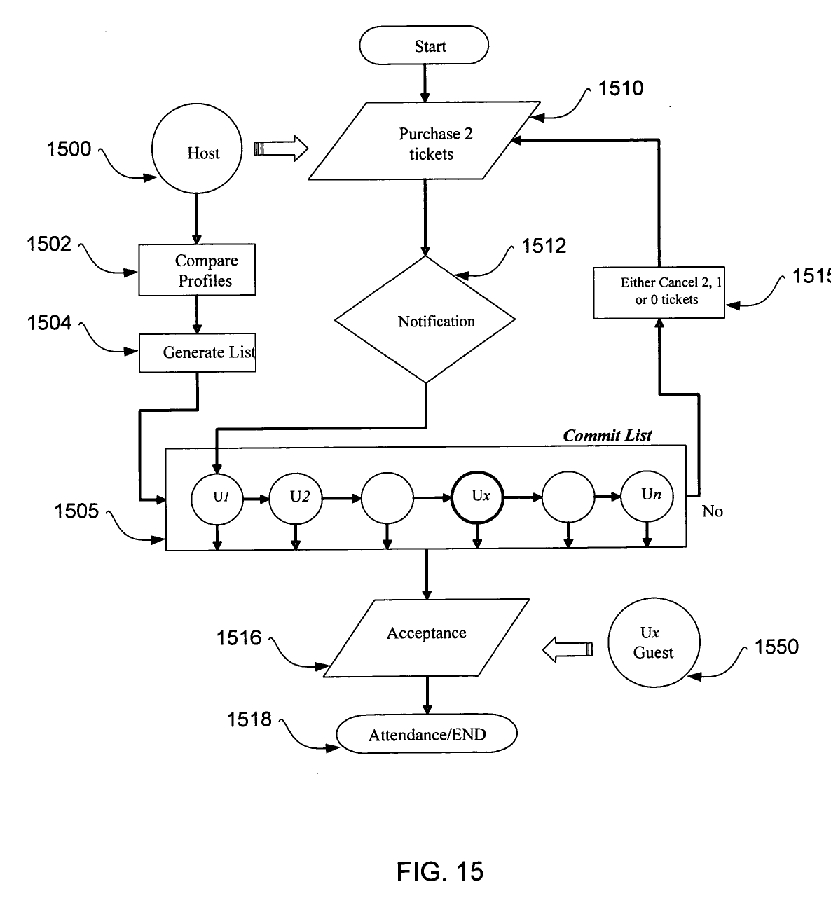

FIG. 15 is a flow chart of a method for a committed guest to accept an invitation from a host who requests a profile match of available committed guests, wherein the host purchases the tickets when initiating the invitation. As in cases described above, a host 1500 may compare profiles (1502) to generate a profile list (1504) such that a list of committed users 1505 may be assembled, but the host 1500 may not see the profiles in the list. The host 1500 may purchase two tickets (1510) to an event and let the profile matching system determine the best match among committed users (U1-Un). An invitation is communicated to the first matching profile (U1) and the first committed user may then choose to accept the invitation (1516) or decline the invitation. In some embodiments, a committed user may enable the automatic acceptance of any matching invitation. In other embodiments, the committed user may choose to accept the invitation, and, if so, then the committed user becomes the invited guest 1550 and the purchased tickets are verified such that the host 1500 and the invited guest 1550 may attend the event 1518. If the first committed user U1 declines the invitation, then the next best profile match is tried until no more matches are in the committed profile list. When this occurs, a cancellation notice may be sent to the host 1500 and to the ticketing server computer and the purchased tickets may be returned and refunded. In a committed user situation, the arrangement that the host purchase both tickets is not necessarily required as described below.

In a related embodiment, a host user may simply be purchasing a ticket to an event by invoking a transaction via a direct exchange with a ticketing server computer. This may typically be a situation where the user has already chosen to go to some event without using the invitation system. At the time of purchase, however, the user may receive a notice that there exists one or more potential guests that have designated the host's chosen event as one for which they would be committed users. Thus, the host user may be given an opportunity to extend an invitation to potential guests by responding to the notice. The notice may typically be an email or a blinking hyperlink on a web page.

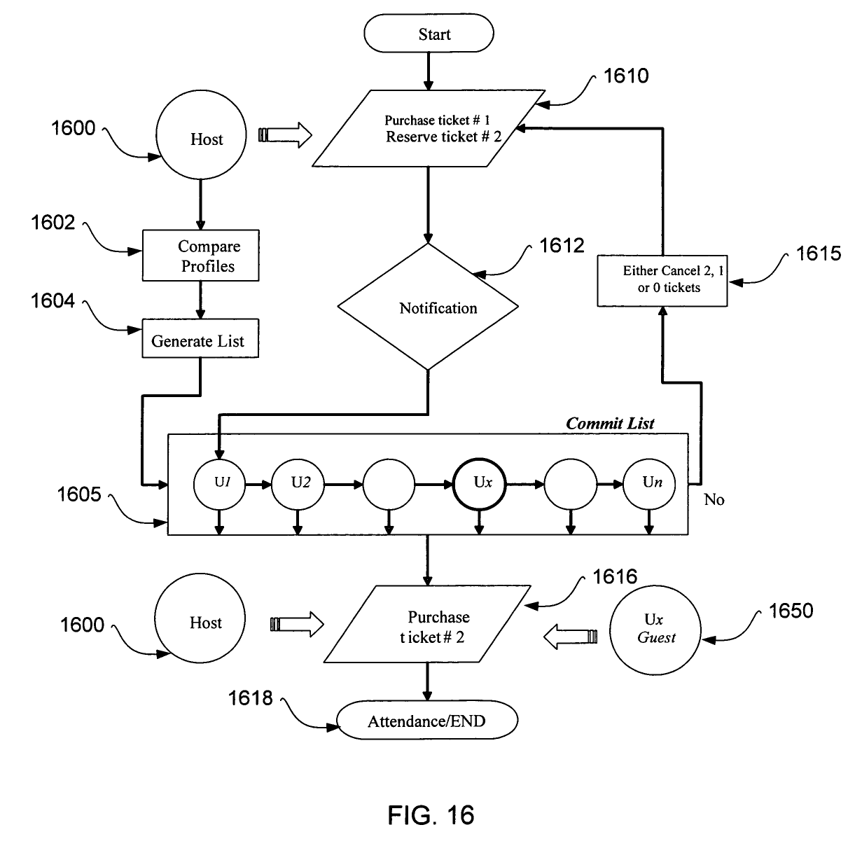

FIG. 16 is a flow chart of a method for a committed guest to accept an invitation from a host who requests a profile match of hidden guests, wherein the host requests the committed guest to purchase the tickets when initiating the invitation. Again, a host 1600 may compare profiles (1602) to generate a profile list (1604) such that a list of committed users 1605 may be assembled, but again the host 1600 may not see the profiles in the list, but rather just an order for the listings. The host 1600 may also reserve two tickets (1610) (or purchase one and reserve another) to an event and let the profile matching system determine the best match among committed users (U1-Un). An invitation is communicated to the first matching profile (U1) and the first committed user may then choose to accept (if automatic acceptance is not enabled) the invitation (1616) or decline the invitation. If the committed user accepts the invitation, then the committed user becomes the invited guest 1650 and the purchase of one or both tickets by the host or the guest are arranged and verified such that the host 1600 and the invited guest 1650 may attend the event 1618. If the first committed user U1 declines the invitation, then the next best profile match is tried until no more matches are in the committed profile list 1605. When this occurs, a cancellation notice may be sent to the host 1600 and to the ticketing server computer and any purchased/reserved tickets may be returned and refunded. This committed user method may be further modified to include provisions for the host to review the committed user profile lists as described below.

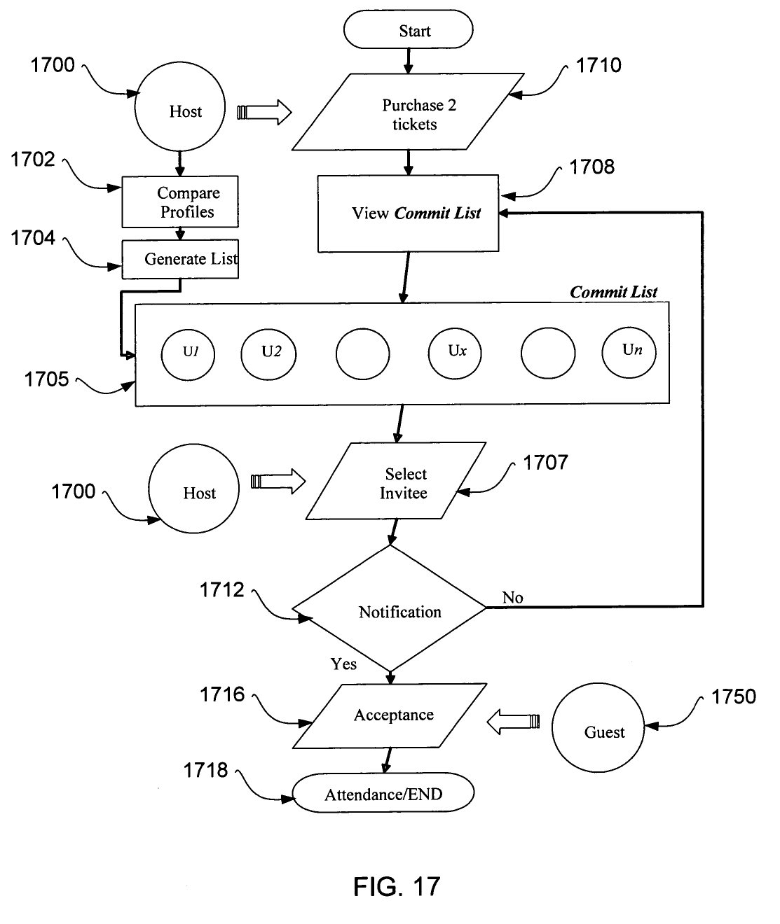

FIG. 17 is a flow chart of a method for a committed guest to accept an invitation from a host who requests a profile match of multiple committed guests, wherein the host selects one committed guest and then purchases the tickets when initiating the invitation. As in cases described above, a host 1700 may compare profiles (1702) to generate a profile list (1704) such that a list of committed users 1705 may be assembled. In this embodiment, the host 1700 may, in fact, view (1708) the matching profiles and rank (1707) among them in which order they are to receive invitations. The host 1700 may also purchase two tickets (1710) to an event and let the profile matching system determine a list of committed users (U1-Un). An invitation is communicated (1712) to the highest ranked matching profile and the corresponding committed user may then choose to accept (if automatic acceptance is not enabled) the invitation (1716) or decline the invitation. If the corresponding committed user accepts the invitation, then he or she becomes the invited guest 1750 and the purchased tickets are verified such that the host 1700 and the invited guest 1750 may attend the event 1718. If the highest ranked committed user U1 declines the invitation, then the next highest ranked profile match is tried until no more matches are in the committed profile list 1705. When this occurs, a cancellation notice may be sent to the host 1700 and to the ticketing server computer and the purchased tickets may be returned and refunded. As before, the arrangement that the host purchase both tickets is not necessarily required as described below.

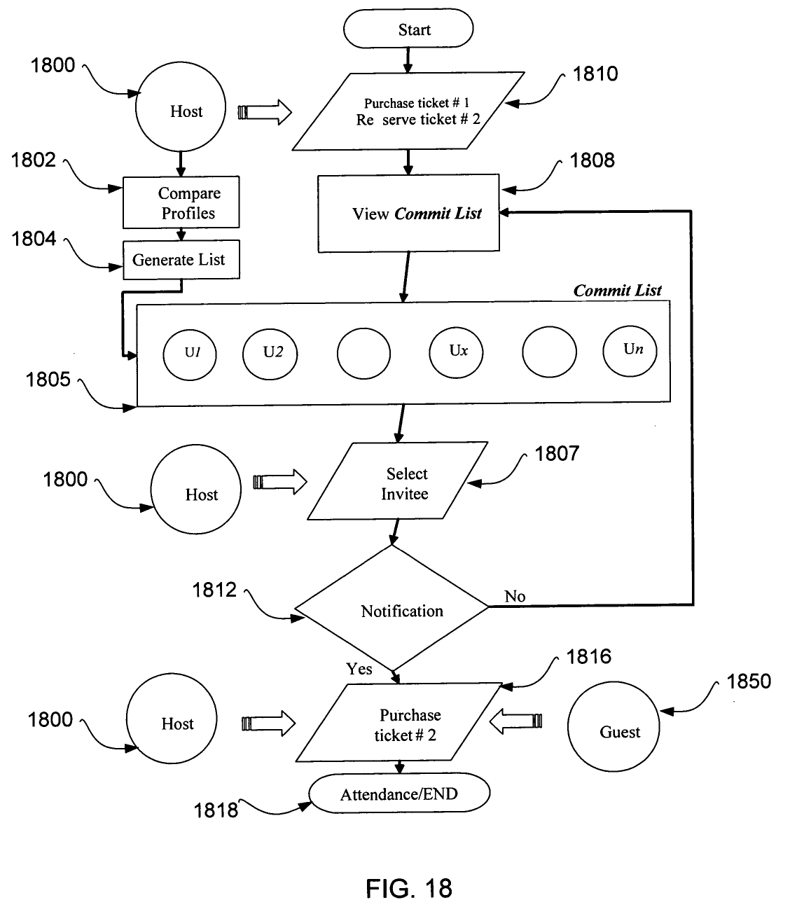

FIG. 18 is a flow chart of a method for a committed guest to accept an invitation from a host who requests a profile match of multiple guests, wherein the host selects one committed guest and requests the invited guest to purchase the tickets when initiating the invitation. Again, a host 1800 may compare profiles (1802) to generate a profile list (1804) such that a list of committed users 1805 may be assembled. In this embodiment, the host 1800 may, in fact, view (1808) the profiles in the matching profile and choose (1807) among them which order they are to receive invitations. The host 1800 may also reserve two tickets (1810) (or purchase one and reserve another) to an event and let the profile matching system determine the best matches among committed users (U1-Un). An invitation is communicated (1812) to the first chosen matching profile (U1) and the chosen committed user may then choose to accept (if automatic acceptance is not enabled) the invitation (1816) or decline the invitation. If the chosen committed user accepts the invitation, then the committed user becomes the invited guest 1850 and the purchase of one or both tickets are arranged and verified such that the host 1800 and the invited guest 1850 may attend the event 1818. If the first chosen committed user U1 declines the invitation, then the next chosen profile match is tried until no more matches are in the committed profile list 1805. When this occurs, a cancellation notice may be sent to the host 1800 and to the ticketing server computer and any purchased/reserved tickets may be returned and refunded.

While the invention may be susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

We claim:

1. A computer-implemented method for coordinating attendance of an event, the method comprising:
at a host computer associated with a host, selecting an event from a plurality of events, the event associated with a special arrangement for a attendance to the event;
sending notification to at least one computer associated with an invited guest about the reservation, the notification including an invitation to the event; and
in response to the invited guest accepting the invitation, invoking a transaction for completing the special arrangement.

2. The method of claim 1 wherein the event comprises a sporting event.

3. The method of claim 1 wherein the event comprises a concert.

4. The method of claim 1 wherein invoking the transaction further comprises purchasing a ticket to the event.

5. The method of claim 1, further comprising automatically invoking the transaction such that completing the special arrangement comprises purchasing reserved tickets using an account associated with the user of the host computer in response to the invited guest acceptance.

6. The method of claim 1, further comprising automatically invoking the transaction such that completing the special arrangement comprises purchasing reserved tickets using an account associated with the invited guest in response to the invited guest acceptance.

7. The method of claim 1, further comprising:
reserving at least one ticket prior to sending the notification;
confirming the reservation by purchasing the ticket in response to an acceptance of the invitation; and
canceling the reservation in response a decline of the invitation.

8. The method of claim 1, further comprising:
reserving a plurality of tickets associated with the event; and
sending a plurality of notifications to at least one computer associated with each of a plurality of invited guests about the reservation, the notifications including an invitation to the event.

9. The method of claim 8, wherein invoking the transaction further comprises purchasing a number of tickets in response to one or more invited guests accepting the invitation, the number of tickets purchased equal to the number of invited guests that accept the invitation.

10. The method of claim 9, further comprising purchasing the tickets only if a specific invited guest accepts the invitation.

11. The method of claim 9, further comprising purchasing the tickets only if a threshold number of invited guest accepts the invitation.

12. The method of claim 9 wherein each invited guest is associated with a rating and the tickets are purchased only if a specific rating threshold of invited guests accepts the invitation.

13. The method of claim 1, further comprising:
determining a plurality of potential guests based on a comparison of a profile associated with the host and profiles associated with a plurality of potential guests; and
selecting an invited guest among the potential guests to receive the invitation based on a profile matching algorithm.

14. The method of claim 1, further comprising:
determining a plurality of potential guest based on a comparison of a profile associated with the host and profiles associated with a plurality of potential guests;
viewing the profiles of the determined potential guests; and
selecting one invited guest among the plurality of potential guests to receive the invitation based an input by the user.

15. The method of claim 1, further comprising:
determining a plurality of potential guest based on a comparison of a profile associated with the host and profiles associated with a plurality of potential guests, each of the plurality of potential guests associated with a profile indicating a commitment to attend a specific event; and
selecting an invited guest among the plurality of potential guests to receive the invitation based on a profile matching algorithm.

16. The method of claim 1, further comprising:
determining a plurality of potential invited guest based on a comparison of a profile associated with the host and profiles associated with a plurality of potential invited guests, each of the plurality of potential invited guests associated with a profile indicating a commitment to attend a specific event;
viewing the profiles of the determined potential invited guests; and
selecting one invited guest among the plurality of potential guests to receive the invitation based an input by the user.

17. The method of claim 1, further comprising:
determining a plurality of potential guest based on a comparison of a profile associated with the host and profiles associated with a plurality of potential guests;
sending an invitation to each of the potential guests; and
establishing the first potential guest to meet a specific criterion, as the invited guest.

18. A computer system for coordinating attendance of an event, the system comprising:
a host computer system operable to generate an association of an event to a special arrangement for attending the event and operable to generate an invitation to the event such that an acceptance of the invitation triggers a transaction associated with the special arrangement;
a guest computer system operable to receive the invitation and operable to generate an acceptance of the invitation; and
an application server coupled to the host computer system and to the guest computer system, the application server operable to coordinate the delivery and acceptance of the invitation and to conclude the transaction based upon an acceptance of the invitation.

19. The computer system of claim 18, further comprising a ticketing computer system coupled to the application server system and operable to coordinate the association of the event and operable to enable the transaction upon acceptance of the invitation.

20. The computer system of claim 18, further comprising additional host computers and invited guest computers in a distributed computer network.

21. The computer system of claim 18, further comprising a profile matching computer coupled to the application server computer and operable to store user profiles associated a host user and a guest user, the profile matching computer further operable to generate a match based on a comparison of stored profiles when requested by a host computer.

22. A computer-readable medium having computer-executable instruction for:
enabling the selection of an event among a plurality of events, the event requiring a special arrangement for attendance;
generating an invitation to be communicated to an invited guest, the invitation associated with the event;
receiving an acceptance of the invitation from an invited guest; and
in response to receiving the acceptance, initialing a transaction to complete the special arrangements required for attendance of the event.

23. The computer-readable medium of claim 22 having further computer-executable instruction for reserving a ticket to the event prior to generating the invitation.

24. The computer-readable medium of claim 22 having further computer-executable instruction for requesting a profile match to determine the invited guest.

25. A computer-readable medium having computer-executable instruction for:
receiving a communication associated with an invitation to an event, the invitation received from an event host;
generating an acceptance to the invitation, such that acceptance of the invitation initiates a transaction for completing a special arrangement for enabling attendance to the event; and
communicating the acceptance to the host.

26. The computer-readable medium of claim 25 having further computer-executable instruction for generating a declination of the invitation and a cancellation of a reservation of a ticket to the event.

27. The computer-readable medium of claim 25 having further computer-executable instruction for arranging for the purchase of one or more tickets from an account associated with the recipient of the invitation in response to an acceptance of the invitation.

28. A computer-readable medium having computer-executable instructions for:
receiving a communication associated with an invitation to a event, the invitation from a host to an invited guest;
forwarding the invitation to the invited guest;
receiving a communication associated with an acceptance of the invitation; and
coordinating a transaction enabling the host and the guest to attend the event in response to receiving the communication associated with the acceptance of the invitation.

29. The computer-readable medium of claim 28 having further computer-executable instructions for receiving a communication associated with reserving tickets to the event prior to receiving the communication associated with the invitation.

30. The computer-readable medium of claim 29 having further computer-executable instructions for canceling the reservations in response to a declination of the invitation.

31. The computer-readable medium of claim 22 having further computer-executable instructions for:
receiving a communication associated with an invitation to a event, the invitation from the invited guest to a second invited guest;
forwarding the invitation to the second invited guest;
receiving a communication associated with an acceptance of the invitation; and
coordinating a transaction enabling the first invited guest and the second invited guest to attend the event in response to receiving the communication associated with the acceptance of the invitation.
